(19) United States
(12) Patent Application Publication
(10) Pub. No.: US 2005/0059493 A1
(43) Pub. Date: Mar. 17, 2005

(54) Remote gaming system

(75) Inventors: Chris Tyson, Austin, TX (US); Steven Campbell, Las Vegas, NV (US); Terry Tyndall, Las Vegas, NV (US)

Correspondence Address: Kelly K. Kordzik;Winstead Sechrest & Minick P.C., P.O. Box 50784, Dallas, TX, 75201, US

(73) Assignee: Onesource Power Corporation, Ausitn, TX (US)

(21) Appl. No.: 10/928,376

(22) Filed: Aug. 27, 2004

Related U.S. Application Data
(60) Provisional application No. 60/498,846, filed on Aug. 29, 2003.

(51) Int. Cl. G06F 17/00

(52) U.S. Cl. 463/42

(57) ABSTRACT

A system, computer program product and method for playing casino games in a remote location. Input from a user of a terminal selecting a casino game to be played on the terminal may be received. The selected casino game may then be displayed on the terminal. Input from the user of the terminal selecting a play in the displayed casino game may be further received. A table may be searched to determine an action the user of the terminal selected to be performed in the casino game using the input from the user. The action to be performed in the casino game may then be transmitted to a processor of a gaming device. A next screen to be displayed to the user after the user's selected action is performed may be received from the gaming device. This next screen may be transmitted to the terminal to be displayed to the user.

### TECHNICAL FIELD

The present invention relates to the field of gaming systems, and more particularly to a gaming system that allows individuals to play casino games in a remote location, e.g., hotel room, restaurants, swimming pool, on a television set using a single remote control.

### BACKGROUND INFORMATION

In the past, a player wishing to wager on a game of chance such as those offered in a casino had a limited number of options. In order to wager on casino games, such as roulette, blackjack, poker and the like, the player may have had to physically travel to a gaming establishment specifically engaged in such activities or to a location where stand-alone gambling devices, such as video poker terminals or slot machines, were available.

However, as a result of advances in computer technology and telecommunications, remote gaming systems have been devised. One such system allows a player to proceed to gamble against the casino at a remote player station which includes a live game display to permit the player to engage in actual games of chance as they are being played in real-time at a croupier station comprised of one or more gaming tables in the casino. The player station includes a changeable keyboard communicating with a microprocessor for displaying a selected one of a plurality of wagering possibilities corresponding to a selected one of the plurality of games being played and for displaying the results of the game being played. However, the player can gamble only in games being actually conducted in the gaming establishment and monitored over real-time closed circuit video. Moreover, such a system has limited practicality since the player can only gamble on a specialized gaming station which must be electronically linked to the casino. Further, the system is complex and costly by requiring an expensive player station in order to enable a player to communicate with the croupier station.

Another remote gaming system has been developed that allows a player to wager on a casino game without the game being played in real-time at a croupier station. The player wagers on the casino game from a personal computer or portable computer device. The computer stores software that enables the player to obtain gambling credit and cash-out any resulting winnings. However, this system is not convenient for a player desiring to wager from remote locations such as in a hotel room, swimming pool or restaurant. Further, the system is complex and costly by requiring computers loaded with expensive software to be installed at each remote location.

Therefore, there is a need in the art for a less expensive remote gaming system that takes advantage of existing infrastructure yet provides the player an ability to wager on a casino game of his/her choice without requiring the casino game being played in real-time at a croupier station.

### BRIEF DESCRIPTION OF THE DRAWINGS

A better understanding of the present invention can be obtained when the following detailed description is considered in conjunction with the following drawings, in which:

FIG. 1 illustrates a remote gaming system configured in accordance with the present invention;

FIG. 2 illustrates an embodiment of the present invention of a traffic manager;

FIG. 3 illustrates an embodiment of the present invention of an interface board;

FIG. 4 illustrates a table, configured in accordance with the present invention, to translate a user's input to a command for a gaming device;

FIG. 5 illustrates an embodiment of the present invention of user input devices connected to the terminal in the remote gaming system; and

FIG. 6 is a flowchart of one embodiment of the present invention of a method for playing casino games in a remote location, e.g., hotel room, restaurants, swimming pool, on a terminal using a single input device.

### SUMMARY

In one embodiment of the present invention, a method for playing casino games in a remote location may comprise the step of receiving input from a user of a terminal selecting a casino game to play on the terminal. The method may further comprise displaying the casino game on the terminal. The method may further comprise receiving input from the user of the terminal selecting a play in the casino game. The method may further comprise searching a table to determine an action the user of the terminal selected to be performed in the casino game using the input from the user of the terminal. The method may further comprise transmitting the action to be performed in the casino game to a processor of a gaming device. The method may further comprise receiving from the gaming device a next screen to be displayed to the user in the casino game after the user's selected action is performed. The method may further comprise transmitting to the terminal the next screen to be displayed to the user.

The foregoing has outlined rather generally the features and technical advantages of one or more embodiments of the present invention in order that the detailed description of the invention that follows may be better understood. Additional features and advantages of the invention will be described hereinafter which may form the subject of the claims of the invention.

### DETAILED DESCRIPTION

In the following description, numerous specific details are set forth such as specific materials to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

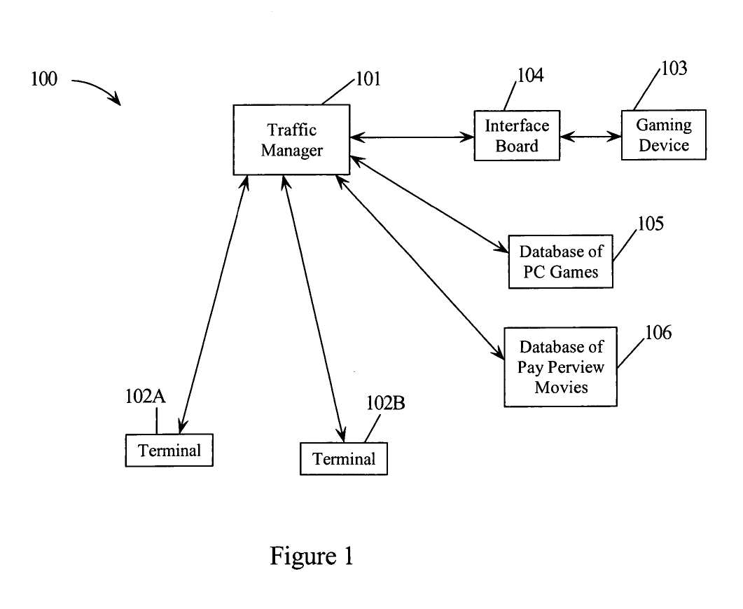

FIG. 1—Remote Gaming System

FIG. 1 illustrates an embodiment of the present invention of a remote gaming system 100. Remote gaming system 100 may comprise a traffic manager 101 coupled to one or more terminals 102A-B, e.g., television sets. Terminals 102A-B may collectively or individually be referred to as terminals 102 or terminal 102, respectively. Traffic manager 101 may further be coupled to one or more gaming devices 103, e.g., black jack, roulette, craps, via one or more interface boards 104. Traffic manager 101 may further be coupled to a database of Personal Computer (PC) games 105, e.g., arcade games, and to a database of pay per view movies 106. It is noted that remote gaming system 100 may comprise any number of gaming devices 103, databases of PC games and movies 105, 106 as well as any number of terminals 102. It is further noted that remote gaming system 100 may include other and/or additional elements that, for clarity, are not depicted. It is further noted that FIG. 1 is illustrative of an embodiment of gaming system 100 but the principles of the present invention is not to be limited in scope to any one particular embodiment.

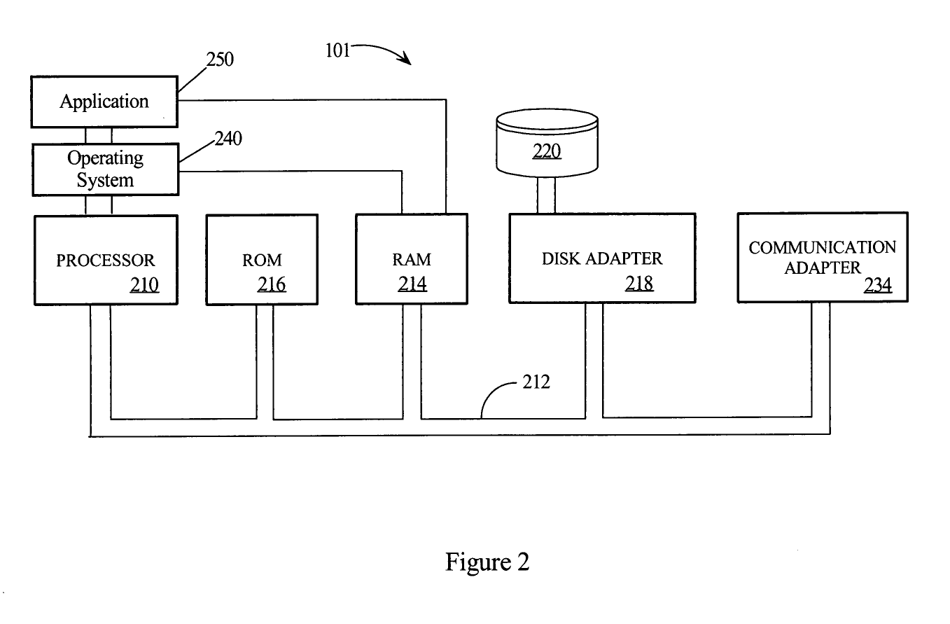

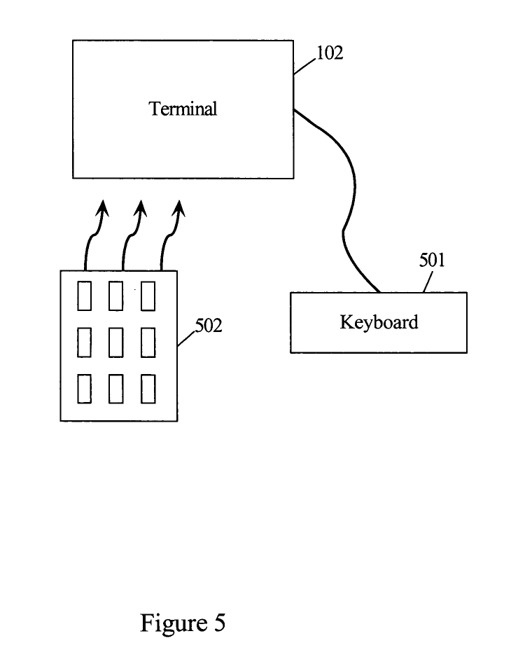

Referring to FIG. 1, traffic manager 101 may be configured to route communications between a user of terminal 102 and a designated gaming device 103, database of PC games 105 or database of pay per view movies 106. In particular, traffic manager 101 may be configured to select the particular PC game or particular movie in database 105, 106, respectively, as identified by a user of terminal 102. A detail description of the user inputting information, such as identifying a particular PC game or movie, to terminal 102 is provided further below in association with FIG. 5. Further, traffic manager 101 may be configured to display on terminal 102 a casino game, e.g., blackjack, of gaming device 103, a PC game in database 105 selected by the user of terminal 102, or a movie in database 106 selected by the user of terminal 102. It is noted that systems that allow a user to select a movie or PC game to view or play is known in the art and consequently will not be described in detail for the sake of brevity. A more detail description of traffic manager 101 is provided below in association with FIG. 2.

Gaming device 103 may refer to a unit configured to store software to run one or more casino games, e.g., black jack, craps, for a user of terminal 102. The software in gaming device 103 may further be configured to track the amount of winnings and losses of each casino game played by a user of terminal 102 as required by a state gaming commission. A user of terminal 102 may be configured to communicate with gaming device 103 via interface board 104.

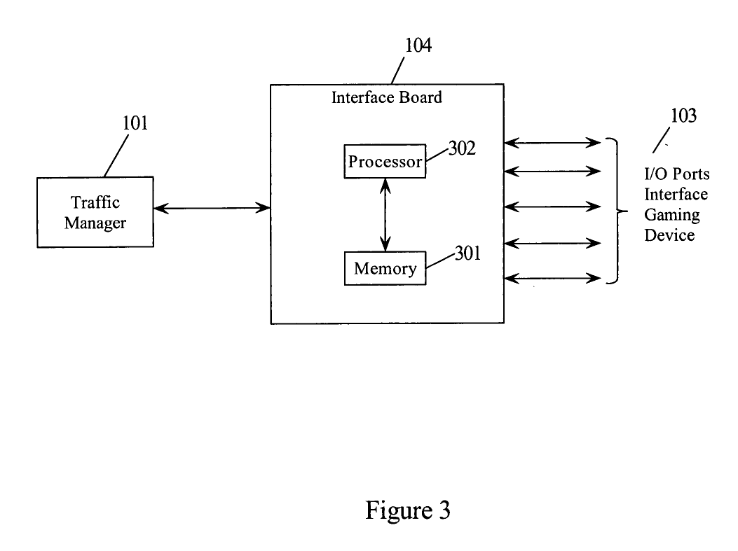

Interface board 104 may be configured to enable a user of terminal 102 to communicate with gaming device 103 via the current gaming industry standard, e.g., SAS™, thereby enabling the user to play the casino game of his/her choice on terminal 102 using a single remote control or keyboard as described in further detail below. A more detail description of interface board 104 is provided below in association with FIG. 3.

FIG. 2—Traffic Manager

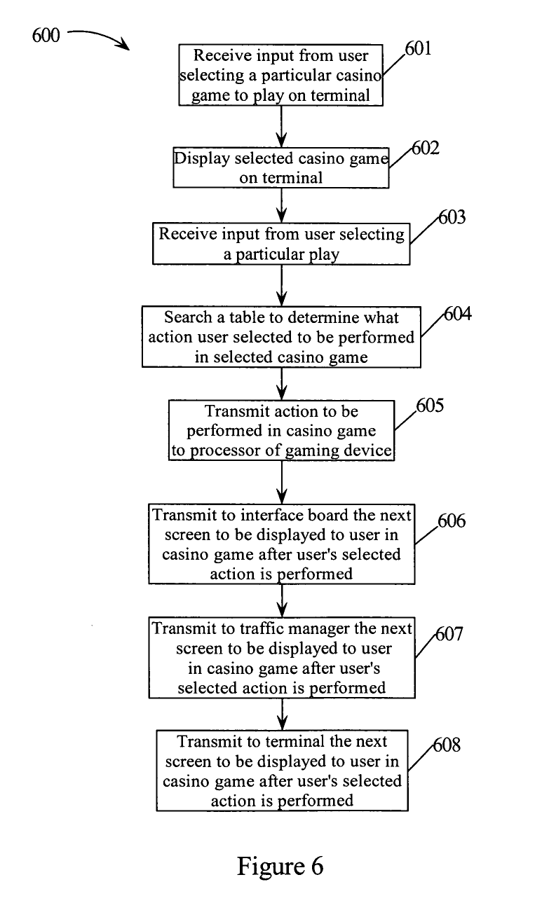

FIG. 2 illustrates an embodiment of the present invention of traffic manager 101. Referring to FIG. 2, traffic manager 101 may comprise a processor 210 coupled to various other components by system bus 212. An operating system 240 may run on CPU 210 and provide control and coordinate the function of the various components of FIG. 2. An application 250 in accordance with the principles of the present invention may run in conjunction with operating system 240 and provide calls to operating system 240 where the calls implement the various functions or services to be performed by application 250. Application 250 may include, for example, a program for routing communications between a user of terminal 102 and a designated gaming device 103, database of PC games 105 or database of pay per view movies 106. In another example, application 250 may further include a program for displaying on terminal 102 a casino game, e.g., blackjack, of gaming device 103, a PC game in database 105 selected by the user of terminal 102, or a movie in database 106 selected by the user of terminal 102. In another example, application 250 may further include a program for playing casino games in a remote location as described in association with FIG. 6.

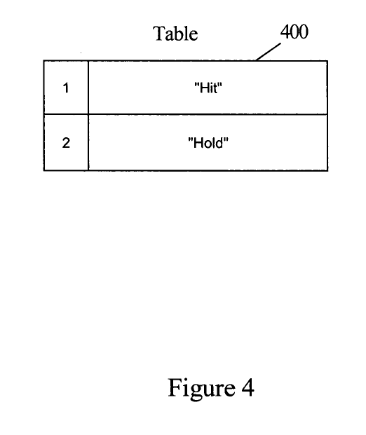

Referring to FIG. 2, Read-Only Memory (ROM) 216 may be coupled to system bus 212 and include a basic input/output system (“BIOS”) that controls certain basic functions of traffic manager 101. In one embodiment, ROM 216 may be configured to store a table configured to map a particular user input to a particular play in a casino game as discussed in greater detail below in association with FIGS. 4 and 5. Random access memory (RAM) 214, disk adapter 218 and communications adapter 234 may also be coupled to system bus 212. RAM 214 may be traffic manager's 101 main memory for execution. Disk adapter 218 may be a small computer system interface (“SCSI”) adapter that communicates with disk units 220, e.g., disk drive. In one embodiment, disk unit 220 may be configured to store a table configured to map a particular user input to a particular play in a casino game as discussed in greater detail below in association with FIGS. 4 and 5. Communications adapter 234 may interconnect bus 212 with traffic manager 101 enabling traffic manager 101 to communicate with terminal 102 (FIG. 1) and interface board 104 (FIG. 1).

Preferred implementations of the invention include implementations as a computer system programmed to execute the method or methods described herein, and as a computer program product. According to the system implementations, sets of instructions for executing the method or methods are resident in the random access memory 214 of one or more systems configured generally as described above. Until required by traffic manager 101, the set of instructions may be stored as a computer program product in another computer memory, for example, in disk drive 220 (which may include a removable memory such as an optical disk or floppy disk for eventual use in disk drive 220). Furthermore, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 3—Interface Board

FIG. 3 illustrates an embodiment of the present invention of interface board 104 interfacing gaming device 103 with traffic manger 101.

Referring to FIG. 3, interface board 104 may comprise a memory 301, e.g., non-volatile memory, to store a program to perform some of the steps of a method for playing casino games in a remote location as described further below in association with FIG. 6. Memory 301 may further be configured to store a table for converting a particular play with a particular port of interface board 104 as discussed further below in association with FIGS. 4 and 5. Interface board 104 may further comprise a processor 302 coupled to memory 301. Processor 302 may be configured to execute the instructions of the program stored in memory 301. It is noted that the steps of the method performed by the program mentioned above may in an alternative embodiment be implemented in hardware such as in an Application Specific Integrated Circuit (ASIC).

Interface board 104 may further comprise a plurality of input/output ports coupled to gaming device 103 and a port coupled to traffic manager 101. Traffic manager 101 may be configured to receive a signal from a user of terminal 102 indicating a particular play, e.g., “hit” in the game of blackjack, in the casino game of gaming device 103 displayed on terminal 102. For example, a user of terminal 102 may select to “hit” in the game of blackjack displayed on terminal 102. Traffic manager 101 may be configured to interpret the user's input to a particular play, e.g., “hit,” using a table as illustrated in FIG. 4.

Referring to FIG. 4, FIG. 4 illustrates an embodiment of the present invention of a table 400 configured to translate a user's input to a particular play for a casino game currently being displayed on terminal 102 (FIG. 1). In one embodiment, table 400 may comprise a listing of entries that translate the user's particular input with a particular play in the casino game currently being displayed on terminal 102. In one embodiment, table 400 may be stored in non-volatile memory 216 or disk unit 220 in traffic manager 101 (FIGS. 1-2). User's input may be received by traffic manager 101 via input devices coupled to terminal 102 as illustrated in FIG. 5.

Referring to FIG. 5, FIG. 5 illustrates an embodiment of the present invention of terminal 102 coupled to a keyboard 501 or a remote control 502. In one embodiment, the user of terminal 102 may input commands, e.g., selecting a play, PC game or movie, via pressing buttons on keyboard 501 or on remote control 502. For example, the casino game of gaming device 103 (FIG. 1) may be displayed on terminal 102 where the displayed casino game includes a listing of optional plays, e.g., “hit”, “hold,” to play in the casino game, e.g., blackjack, displayed on terminal 102. Associated with each play may be a designated alphanumeric key, e.g., number #1, that may be selected by the user of terminal 102 on remote control 502 or on keyboard 501. It is noted that system 100 (FIG. 1) may comprise other input devices than depicted and that such input devices would be known to a person of ordinary skill in the art. It is further noted that embodiments incorporating such input devices would fall within the scope of the present invention. It is further noted that by illustrating both keyboard 501 and remote control 502 that it is not to be implied that both input devices are required to communicate with gaming device 103 (FIG. 1), databases 105, 106 (FIG. 1) via traffic manager 101 (FIGS. 1-2). For example, system 100 may comprise only a single input device such as remote control 502.

Returning to FIGS. 1, 4 and 5, upon the user of terminal 102 selecting a particular play, e.g., “hit,” via an input device, e.g., remote control 502, the selected alphanumeric key, e.g., numeral #1, is transmitted to traffic manager 101. Traffic manager 101 may be configured to search through table 400 for the play associated with the user's selected alphanumeric key. For example, as illustrated in FIG. 4, if the user selected numeral #1, then the user had selected the play “hit” in the casino game displayed on terminal 102.

Traffic manager 101 may then be configured to output a signal indicating the particular play to interface board 104. Interface board 104 may then be configured to output the user's selected play to gaming device 103 through the appropriate port associated with the selected play. For example, interface board 104 may output the user's selected play through the appropriate port associated with the play “hit.” In one embodiment, interface board 104 may comprise memory 301 that stores a table for converting a particular play with a particular port of interface board 104.

Gaming device 103 may then transmit to interface board 104 the next screen to be displayed to terminal 102 which is then forwarded to traffic manager 101 which is then forwarded to terminal 102.

While the above describes storing table 400 in traffic manager 101, in an alternative embodiment, table 400 may be stored in memory 301. In such an embodiment, interface board 104 may be configured to map a particular user input to a particular play in a casino game.

As stated in the Background Information section, a remote gaming system has been developed that allows a player to wager on a casino game without the game being played in real-time at a croupier station. The player wagers on the casino game from a personal computer or portable computer device. The computer stores software that enables the player to obtain gambling credit and cash-out any resulting winnings. However, this system is not convenient for a player desiring to wager from remote locations such as in a hotel room, swimming pool or restaurant. Further, the system is complex and costly by requiring computers loaded with expensive software to be installed at each remote location. Therefore, there is a need in the art for a less expensive remote gaming system that takes advantage of existing infrastructure yet provides the player an ability to wager on a casino game of his/her choice without requiring the casino game being played in real-time at a croupier station. A method for allowing individuals to play casino games in a remote location, e.g., hotel room, restaurants, swimming pool, on a terminal 102, e.g., television set, using a single input device, e.g., remote control 502, is described below.

FIG. 6—Method for Playing Casino Games in a Remote Location

FIG. 6 is a flowchart of one embodiment of the present invention of a gaming system that allows individuals to play casino games in a remote location, e.g., hotel room, restaurants, swimming pool, on a terminal 102 (FIG. 1), e.g., television set, using a single input device, e.g., remote control 501 (FIG. 5).

Referring to FIG. 6, in conjunction with FIGS. 1-6, in step 601, traffic manager 101 receives input from the user of terminal 102 selecting a particular casino game to play on terminal 102. For example, the user of terminal 102 may select a particular casino game, e.g., blackjack, slot machine, craps, to play on terminal 102 based on a menu of casino games that appears on terminal 102.

In step 602, traffic manager 101 displays the user's selected casino game on terminal 102. As stated above, traffic manager 101 may be configured to communicate with gaming device 103 that stores the user's selected casino game. Further, as stated above, traffic manager 101 may be configured to retrieve and display to terminal 102 the user's selected casino game.

In step 603, traffic manager 101 receives input, e.g., numeral #1 on remote control 502, from the user of terminal 102 selecting a particular play, e.g., “hit,” in the casino game, e.g., blackjack, displayed on terminal 102.

In step 604, traffic manager 101 or interface board 104 searches table 400 to determine the action the user selected to be performed in the casino game using the input from the user. As stated above, table 400 may comprise a listing of entries that translate the user's particular input with a particular play in the casino game currently being displayed on terminal 102.

In step 605, interface board 104 transmits the action to be performed in the casino game to the processor of gaming device 103 through the input/output port associated with the user's selected play.

In step 606, interface board 104 receives from gaming device 103 the next screen to be displayed to the user in the casino game after the user's selected action is performed.

In step 607, interface board 104 transmits the next screen to be displayed to the user after the user's selected action is performed.

In step 608, traffic manager 101 transmits to terminal 102 the next screen to be displayed in the casino game after the user's selected action is performed.

It is noted that method 600 may include other and/or additional steps that, for clarity, are not depicted. It is noted that method 600 may be executed in a different order presented and that the order presented in the discussion of FIG. 6 is illustrative. It is further noted that certain steps in method 600 may be executed in a substantially simultaneous manner.

Although the system, computer program product and method are described in connection with several embodiments, it is not intended to be limited to the specific forms set forth herein; but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for playing casino games in a remote location comprising the steps of:
receiving input from a user of a terminal selecting a casino game to play on said terminal;
displaying said casino game on said terminal;
receiving input from said user of said terminal selecting a play in said casino game;
searching a table to determine an action said user of said terminal selected to be performed in said casino game using said input from said user of said terminal;
transmitting said action to be performed in said casino game to a processor of a gaming device;
receiving from said gaming device a next screen to be displayed to said user in said casino game after said user's selected action is performed; and
transmitting to said terminal said next screen to be displayed to said user.
